(19) United States
(12) Patent Application Publication
(10) Pub. No.: US 2013/0068253 A1
(43) Pub. Date: Mar. 21, 2013

(54) SYSTEM AND METHOD FOR PURGING A BEARING AND BEARING HOUSING

(71) Applicants: Miguel A. Gonzalez, Jupiter, FL (US); Daniel M. Brake, Hobe Sound, FL (US); Gregory John Smith, Port St. Lucie, FL (US); Andrew John Simon, Boynton Beach, FL (US)

(72) Inventors: Miguel A. Gonzalez, Jupiter, FL (US); Daniel M. Brake, Hobe Sound, FL (US); Gregory John Smith, Port St. Lucie, FL (US); Andrew John Simon, Boynton Beach, FL (US)

(73) Assignee: Inventus Holdings, LLC, Juno Beach, FL (US)

(21) Appl. No.: 13/237,428

(22) Filed: Sep. 20, 2011

(51) Int. Cl. B08B 3/08; B08B 7/04; B08B 5/04

(52) U.S. Cl. 134/10; 134/105; 134/21

(57) ABSTRACT

A system and method for heating a purging fluid contained in a portable oil sump or reservoir, and pumping the hot purging fluid through a bearing housing in order to purge the bearing and bearing housing of accumulated hardened grease, sludge, and debris. The heated purging fluid can then be suctioned into the sump or reservoir, screened and filtered, and re-circulated through bearing housing to continue purging the bearing and bearing housing.

### FIELD OF THE INVENTION

The present invention relates to systems and methods for purging hardened grease or sludge from the bearing and bearing housing of a wind turbine generator.

### BACKGROUND OF THE INVENTION

The transmission system of a wind turbine generator acts as the link between the wind blade rotor and the generator, and is generally comprised of a hub, main bearing, main shaft, and a gearbox that is secured to a bedding or frame. The main bearing supports the main shaft and transmits reactions from the rotor loads to the frame.

While the quantity and arrangement of a main bearing may vary depending on the model or design of the wind turbine, the main bearing is always lubricated.

The most common lubricant used in the main bearings is grease, which has the advantage of being easily retained in the bearing arrangement, contributes to sealing the bearing arrangement from contamination, and avoids the use of an expensive circulation system.

Over time, however, it is inevitable that dirt and dust will accumulate in the grease as a result of contact with the atmosphere, thereby causing the grease to increase in viscosity and harden into sludge. An accumulation of this hardened grease or sludge will eventually cause the bearing to overheat, exhibit decreased efficiency, and possibly cause bearing failure.

Accordingly, in order to properly maintain the bearing, hardened grease and sludge that has accumulated on the bearing and bearing housing, must be periodically purged from the bearing and bearing housing.

As used herein, “sludge” will be used to refer to used grease and other accumulations in a bearing and bearing housing that are to be purged and replaced, regardless of the state of hardness of the substance. “Purging fluid” will refer to grease, oils, or other substances used in this invention as a purging medium, whether liquid or semi-solid. The purging fluid may further comprise greases or oils which, when applied to the surfaces of the bearing or bearing housing, cause the bearing or bearing housing to oxidize. A non-limiting example of a purging fluid which can cause the surface of a bearing or bearing housing to oxidize is a purging fluid exhibiting caustic properties or characteristics. This oxidation, or “black oxide coat” helps reduce the amount of wear and tear incurred by the bearing and bearing housing, thus increasing the life of the bearing and bearing housing. In alternative embodiments, the purging fluid does not exhibit caustic properties or characteristics, and in yet another embodiment, may exhibit acidic properties which do not cause the surfaces of the bearing or bearing housing to oxidize.

As used herein, “bearing” and “bearing housing” will refer to any bearing system within a transmission system, combustion engine, or the like. As used herein, “bearing” or “bearing housing” also refers to a gear system within a transmission system, combustion engine, or the like, including but not limited to gear system contained with the gearbox of a wind turbine generator's transmission system.

The prior art discloses various systems and methods for circulating filtered and heated lubricants through a wind turbine gearbox.

U.S. Patent Application No. 2009/0191060 describes a system for heating and circulating a lubricating fluid through a gearbox of a wind turbine generator.

U.S. Pat. No. 5,611,411 describes a lubrication delivery system wherein a sump having two chambers receives oil from the turbine generator in the first chamber and supplies filtered oil to the turbine generator from the second chamber.

U.S. Pat. No. 4,971,704 describes a system for purifying and preparing lubricating oil in an internal combustion engine comprising passing oil from the engine sump through a strainer; passing oil from the strainer to a pump; pumping the oil through a heater; passing a portion of the heated oil through a filter and into an oil sending unit; and passing the remainder of the heated oil to a refiner which returns refined oil to the sump.

U.S. Patent Application No. 2005/0034925 discloses a gear unit for a wind turbine generator having a dry sump that is lubricated from an external reservoir whereby a routine oil change may be undertaken by removing the external reservoir containing used oil and replacing it with a reservoir containing fresh oil.

U.S. Patent Application No. 2011/0024236 discloses a lubricating device and method for a wind turbine gearbox comprising an oil storage chamber which stores lubricant oil for lubricating the gearbox; a lubricant oil circulating line which includes a pump and through which the lubricant oil storage chamber is supplied to the gearbox by the pump and then returned to the oil storage chamber; a bypass line which is provided in the oil lubricant circulating line and bypasses the gearbox; and a switching valve which is provided in the oil lubricant circulating line and switches a supply path of the lubricant between supplying the lubricant oil to the gearbox and supplying the lubricant oil to the bypass line.

While the prior art discloses systems and methods for circulating filtered and heated oil through a gearbox, the prior art does not teach a system or method for purging sludge from the bearing and bearing housing. Nor does the prior art disclose a portable apparatus that can be detachably connected to a bearing housing in order to purge the bearing and bearing housing of accumulated sludge.

In the prior art, in order to remove sludge that has accumulated in a bearing and bearing housing, it has been necessary to open the bearing covers and bearing housings in order to manually clean the bearing and bearing housing. This is a timely and cost intensive process that can take a two-man crew several days to complete.

Accordingly, there is a need for a time and cost efficient system and method for purging accumulated sludge from the bearing and bearing housing of a wind turbine generator by utilizing a portable device capable of being detachably connected to the bearing housing.

Although several of the embodiments disclosed herein refer to a main bearing of a wind turbine generator, one of ordinary skill in the art would appreciate that the system and method of the present invention can be equally applied to any variety of bearings or gears and any kind of transmission system, combustion engine, or the like which incorporate lubricated bearings or gears.

### SUMMARY OF THE INVENTION

The present invention generally comprises a portable system that can be detachably connected to a bearing housing of a wind turbine generator. The system and method of the present invention is capable of heating a purging fluid contained in a portable oil reservoir, and pumping the hot purging fluid through a bearing housing in order to purge the bearing and bearing housing of hardened, accumulated sludge. The heated purging fluid is then suctioned into the reservoir, screened and filtered, and re-circulated through the bearing housing.

### DESCRIPTION OF THE DRAWINGS

FIG. 1 is a side view of the transmission system of a wind turbine generator.

FIG. 2 is a diagram showing the arrangement of structural components of the present invention.

### DETAILED DESCRIPTION OF THE PREFERRED EMBODIMENTS

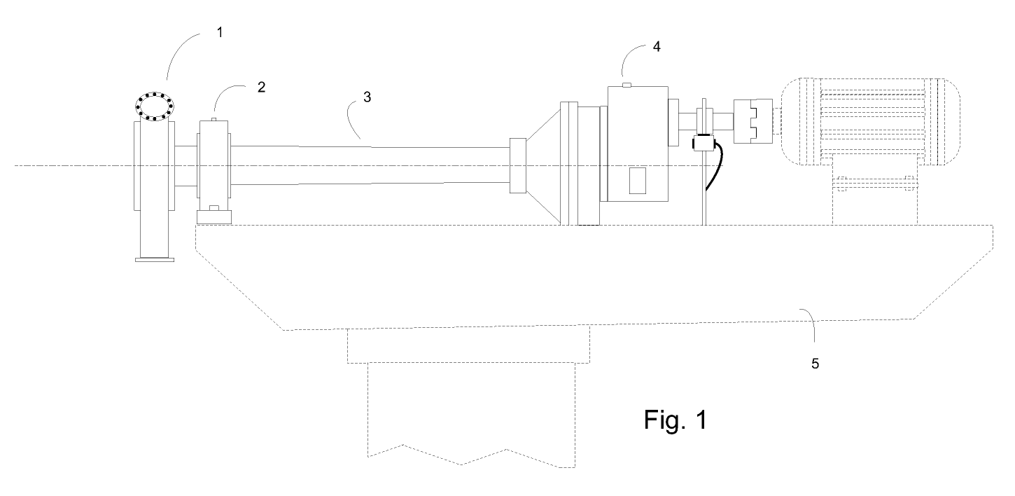

As depicted by FIG. 1, the transmission system of the wind turbine generator comprises a hub 1, a bearing housing 2, a main shaft 3, and a gearbox 4 secured to the bedding or frame 5. The main bearing and bearing housing 2 supports the main shaft 3 and transmits reactions from the rotor loads to the frame 5.

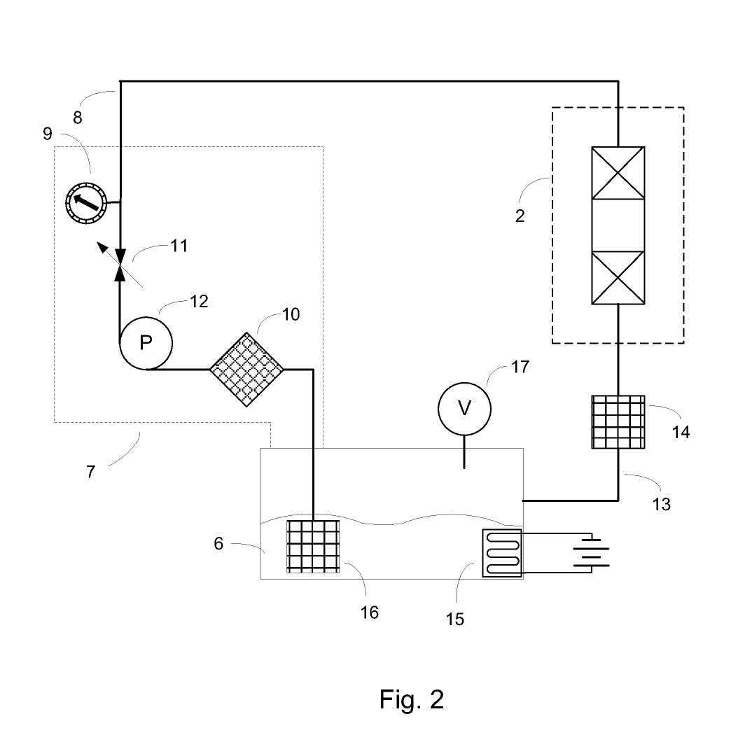

As depicted in FIG. 2, the system of the present invention comprises components including an oil reservoir 6, a manifold block 7, an entry oil line 8, an oil pressure gauge 9, an oil filter 10, a valve 11, an oil pump and motor 12, a return oil line 13, a return oil strainer 14, an immersion heater 15, a reservoir strainer 16, and a vacuum pump 17. Oil reservoir 6 can hold up to five gallons of a purging fluid, including but not limited to grease or oil. As further depicted by FIG. 2, integral to oil reservoir 6 is manifold block 7. The unit comprising oil reservoir 6 and manifold block 7 is portable, and preferably weighs less than 50 lbs.

Entry oil line 8 forms and provides a conduit for purging fluid between oil reservoir 6 and bearing housing 2. Entry oil line 8 has a first end connected to oil reservoir 6 and a second end connected to bearing housing 2. Entry oil line 8 may be further configured with a quick disconnect fitting (not shown) on its first and/or second ends, and may be further configured with a shut-off valve to prevent spillage of the purging fluid flowing into, through and exiting from entry oil line 8.

Oil pressure gauge 9 measures pressure in entry oil line 8. Oil pressure gauge 9 is configured to connect to entry oil line 8, and in a preferred embodiment, is situated on or within manifold block 7.

Oil filter 10 filters particles and debris that may be contained in the purging fluid exiting oil reservoir 6. In a preferred embodiment, oil filter 10 is designed for filtration of high viscosity lubricants, and in some embodiments, comprises a 10 micron filter having a filter efficiency rating of 95% or more. Oil filter 10 is configured to connect to entry oil line 8, and, in a preferred embodiment, is situated on or within manifold block 7, downstream of oil reservoir 6, and upstream of oil pump and motor 12.

In a preferred embodiment, valve 11 comprises a needle valve for controlling the flow of purging fluid out of oil reservoir 6 through entry oil line 8. Valve 11 is configured to connect to entry oil line 8 and may be situated on or within manifold block 7.

Oil pump and motor 12 pump purging fluid contained in oil reservoir 6 into and through entry oil line 13. Oil pump and motor 12 comprise a low flow-rate motor, and in a preferred embodiment, comprise a low-flow rate motor having a 120/240 V AC power supply. Oil pump and motor 12 are configured to connect to oil line 8, and, in a preferred embodiment, are situated on or within manifold block 7, downstream of oil filter 10, and upstream of valve 11.

Return oil line 13 forms and provides a conduit for purging fluid between oil bearing housing 2 and oil reservoir 6. Return oil line 13 has a first end connected to bearing housing 2 and a second end connected to oil reservoir 6. In a preferred embodiment, return oil line 13 is further configured with a quick disconnect fitting (not shown) on its first and/or second ends, and is further configured with a shut-off valve to prevent spillage of purging fluid flowing into, through and exiting from return oil line 13.

Return oil strainer 14 is configured to connect to return oil line 13, and helps trap and prevent large pieces of debris (including but not limited to hardened grease or sludge that was flushed out the bearing and bearing housing) that may be contained in the used purging fluid flowing from bearing housing 2 and through return oil line 13 from entering oil reservoir 6. Return oil strainer 14 may further comprise a sight glass to permit visual observation of the condition of the sludge and purging fluid flowing from bearing and bearing housing 2 and through return oil line 13.

Immersion heater 15 heats purging fluid contained in oil reservoir 6. Immersion heater 15 should be capable of heating purging fluid to temperatures of up to 130° F., which temperature is high enough to ensure that sludge which has accumulated in the bearings and bearing housings being purged will liquefy sufficiently to be carried away with the purging fluid. The system of the present invention may further comprise a heater thermostat (not shown) for controlling the temperature of immersion heater 15.

Reservoir strainer 16 is configured to connect to the first end of entry oil line 8, and helps trap and prevent large pieces of debris that may be in the sludge and purging fluid contained in oil reservoir 6 from getting sucked into oil filter 10 or oil pump and motor 12.

Vacuum pump 17 can be attached to oil reservoir 6 or connected to return oil line 13 and pumps purging fluid that has circulated through bearing housing 2 into and through return oil line 13. The use of vacuum pump 17 helps prevent purging fluid that is being circulated through the bearing housing 2 from flowing in any direction other than into return oil line 13, thus preventing the purging fluid from leaking into undesired locations such as, for example, into the wind turbine's generator. Vacuum pump 17 may further comprise a switch, button, toggle, or the like for activating and deactivating the pump.

The invention further comprises a method of detachably connecting the system disclosed herein to the bearing housing of a wind turbine generator, circulating heated purging fluid into and through the bearing housing, and flushing accumulated debris, including but not limited to hardened grease or sludge, from the bearing and bearing housing.

The method of the present invention comprises the step of situating the portable oil reservoir 6 (containing an appropriate amount and grade of purging fluid, as would be known by one of ordinary skill in the art) and integral manifold block 7 near the bearing housing 2 so that the oil reservoir and manifold block can be moved elsewhere after the bearing and bearing housing have been flushed with the hot purging fluid contained in the oil reservoir, in accordance with method disclosed herein.

The method of the present invention further comprises the step of detachably connecting the second end of entry oil line 8 to the bearing housing with a quick-disconnect fitting, and preferably, by detachably connecting the second end of entry oil line 8 to the grease fitting, grease nipple, Zerk fitting, or Alemite fitting of the bearing housing. The first end of entry oil line 8 should be submerged in the purging fluid contained in oil reservoir 6 so that the purging fluid contained therein can be pumped into and through entry oil line 8.

The first end of entry oil line 8 may be connected to reservoir strainer 16 for straining, trapping, and otherwise preventing large pieces of debris and sludge that may be in the purging fluid from getting sucked into the oil filter 10 or oil pump and motor 12. An oil filter 10 may be connected to entry oil line 8 for filtering particles and debris that may be contained in the purging fluid exiting oil reservoir 6. A valve 11 may be connected to entry oil line 8 for controlling the flow of purging fluid out of oil reservoir 6 through the entry oil line 8. An oil pressure gauge 9 may be connected to entry oil line 8 for measuring pressure in entry oil line 8.

The method of the present invention comprises the further step of detachably connecting the first end of return oil line 13 to the bearing housing with a quick-disconnect fitting. In some embodiments, the first end of return oil line is connected to an access on the bearing housing wherein separated oil may drip out of the bearing housing and into an oil pan or tray while the wind turbine generator is in operation. In other embodiments, a bearing drain plug is removed and the first end of return oil line 13 is attached in place of the bearing drain plug. The second end of the return oil line 13 should be configured to connect to oil reservoir 6 so that purging fluid exiting the return oil line 13 is directed into the oil reservoir 6 without leaking or spillage. A return oil strainer 14 may be connected to the return oil line 13 for straining, trapping, and otherwise preventing large pieces of debris (including but not limited to hardened grease or sludge that was flushed out the bearing and bearing housing) that may be contained in the used purging fluid flowing from bearing housing 2 and through the return oil line 13 from entering the oil reservoir 6.

The method of the present invention further comprises the step of heating the purging fluid contained in the oil reservoir 6, preferably, by utilizing immersion heater 15. The purging fluid should be heated to 130° F. A heater thermostat should be utilized to adjust and monitor the immersion heater so that the temperature of the lubricating medium is maintained at 130° F.

The method of the present invention further comprises the step of activating the oil pump and motor 12, comprising a low flow-rate motor having a 120/240 V AC power supply. The oil pump and motor 12 should be configured to connect to oil line 8, and are preferably situated on or within manifold block 7, downstream of oil filter 10, and upstream of valve 11. Once activated, the oil pump and motor 12 should pump heated purging fluid from the oil reservoir 6 into and through entry oil line 8 and should further pump the heated purging fluid into and through the bearing housing 2. The heated purging fluid should be pumped through the bearing housing at a pressure which adequately purges the bearing and bearing housing of hardened grease or sludge.

The method of the present invention further comprises the step of monitoring the condition of the purging fluid flowing from the bearing housing 2 and through return oil line 13, preferably by visually observing the condition of the purging fluid through a sight glass situated on return oil strainer 14.

In some embodiments, the method of the present invention further comprises the step of rotating the bearing housing while heated purging fluid is being pumped through the bearing housing. Rotating the bearing housing while heated purging fluid is circulating therethrough will further assist loosening and breaking free hardened grease or sludge which has accumulated in the bearing and bearing housing.

The method of the present invention further comprises the step of activating vacuum pump 17, vacuum pump 17 being connected to oil reservoir 6 or connected to return oil line 13. Vacuum pump 17 may further comprise a switch, button, toggle, or the like for activating and deactivating the pump. Once activated, vacuum pump 17 should pump purging fluid into and through return oil line 13 after it has circulated through bearing housing 2. Vaccum pump 17 helps prevent purging fluid from flowing in any direction other than into return oil line 13 thus preventing the purging fluid from leaking into undesired locations such as, for example, into the wind turbine's generator.

The method of the present invention further comprises the steps of deactivating the oil pump and motor 12 and vacuum pump 17; detaching the second end of entry oil line 8 from the bearing housing; detaching the first end of return oil line 13 from the bearing housing; removing the oil reservoir and integrated manifold block; and re-lubricating the bearing with an appropriate grade of grease or oil as would be known and appreciated by one or ordinary skill in the art.

The foregoing description of possible implementations consistent with the present invention does not represent a comprehensive list of all such implementations or all variations of the implementations described. The description of only some embodiments should not be construed as an intent to exclude other embodiments. For example, one of ordinary skill in the art will understand how to implement the invention in other ways, using equivalents and alternatives that do not depart from the scope of the invention. Moreover, unless indicated to the contrary in the preceding description. It is thus intended that the specification and examples be considered as exemplary only, with a true scope and spirit of the invention being indicated by the following claims.

What is claimed is,:

1. A system for purging sludge from a bearing and bearing housing comprising,
a portable oil reservoir containing purging fluid;
an entry oil line forming a conduit for said purging fluid between said oil reservoir and said bearing housing;
an oil pump and motor connected to said entry oil line for pumping purging fluid contained in said oil reservoir into and through said entry oil line;
a return oil line forming a conduit for said purging fluid between said bearing housing and said oil reservoir;
a vacuum pump connected to said return oil line for pumping said purging fluid through said return oil line; and
a heater capable of heating said purging fluid contained in said oil reservoir.

2. The system of claim 1, further comprising a manifold block integrally connected to said oil reservoir.

3. The system of claim 2, further comprising an oil filter configured to connect to said entry oil line.

4. The system of claim 3, said oil filter further comprising a 10 micron filter having a filter efficiency rating of 95% or more.

5. The system of claim 3, said oil filter being situated on or within said manifold block.

6. The system of claim 2, further comprising a valve connected to said entry oil line.

7. The system of claim 6, said valve further comprising a needle valve.

8. The system of claim 7, said valve being situated on or within said manifold block.

9. The system of claim 2, further comprising an oil pressure gauge connected to said entry oil line.

10. The system of claim 9, said oil pressure gauge being situated on or within said manifold block.

11. The system of claim 1, further comprising a return oil strainer connected to said return oil line.

12. The system of claim 11, said return oil strainer further comprising a site glass for visualizing purging fluid passing through said return oil strainer.

13. The system of claim 1, further comprising a reservoir strainer connected to said entry oil line.

14. The system of claim 1, said entry oil line further comprising a quick disconnect fitting connected to at least one end of said entry oil line.

15. The system of claim 1, said entry oil line further comprising a shut-off valve connected to at least one end of said entry oil line.

16. The system of claim 1, said return oil line further comprising a quick disconnect fitting connected to at least one end of said return oil line.

17. The system of claim 1, said return oil line further comprising a shut-off valve connected to at least one end of said return oil line.

18. The system of claim 1, said oil pump and motor comprising a low-flow rate motor.

19. The system of claim 2, said oil pump and motor being situated on or within said manifold block.

20. The system of claim 1, said heater further comprising a thermostat.

21. The system of claim 1, said purging fluid further having caustic characteristics.

22. A method for purging sludge from a bearing and bearing housing comprising the steps of,
obtaining a portable oil reservoir;
submerging a first end of an entry oil line into a purging fluid contained in said oil reservoir;
detachably connecting a second end of said entry oil line to said bearing housing;
detachably connecting a first end of a return oil line to said bearing housing;
connecting a second end of said return oil line to said oil reservoir;
heating said purging fluid contained in said oil reservoir;
activating an oil pump and motor to cause purging fluid contained in said oil reservoir to be pumped into and through said entry oil line and into and through said bearing housing;
activating a vacuum pump to cause said purging fluid to be pumped from said bearing housing into and through said return oil line and into said oil reservoir;
deactivating said oil pump and motor and said vacuum pump; and
detaching said entry and said return oil lines from said bearing housing.

23. The method of claim 22, further comprising the steps of connecting a reservoir strainer between said oil reservoir and said entry oil line, and pumping said purging fluid through said reservoir strainer.

24. The method of claim 22, further comprising the steps of connecting an oil filter between said oil reservoir and said entry oil line, and filtering said purging fluid through said oil filter.

25. The method of claim 22, further comprising the steps of connecting a valve to said entry oil line, and controlling the flow of said purging fluid out of said oil reservoir and through said entry oil line with said valve.

26. The method of claim 22, further comprising the steps of connecting an oil gauge to said entry oil line, and monitoring the pressure of said purging fluid in said entry oil line.

27. The method of claim 22, further comprising the steps of connecting a return oil strainer to said return oil line, and straining said purging fluid through said return oil strainer.

28. The method of claim 27, further comprising the step of observing the condition of said purging fluid passing through said return oil strainer.

29. The method of claim 22, further comprising the step of heating said purging fluid to 130° F.

30. The method of claim 22, further comprising the step of rotating said bearing housing while said purging fluid is being circulated therethrough.

31. The method of claim 22, further comprising the step of integrally connecting a manifold block to said oil reservoir.

32. The method of claim 22, further comprising the step of applying a purging fluid which exhibits caustic properties, thereby causing the surface of said bearing or said bearing housing to oxidize.
